(19) United States
(12) Patent Application Publication
(10) Pub. No.: US 2004/0123161 A1
(43) Pub. Date: Jun. 24, 2004

(54) Portable information processing apparatus and system lock program

(75) Inventors: Yoshihisa Harada, Kawasaki (JP); Naoki Iwasa, Kawasaki (JP); Haruhisa Sakuma, Kawasaki (JP); Makoto Kawasaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/732,291

(22) Filed: Dec. 11, 2003

Related U.S. Application Data
(63) Continuation of application No. PCT/JP01/05175, filed on Jun. 18, 2001.

(51) Int. Cl. H04L 9/32

(52) U.S. Cl. 713/202

(57) ABSTRACT

The present invention relates to a portable information processing apparatus such as a notebook personal computer (hereinafter referred to as a “notebook PC”) which reduces the risk of information theft.

It is equipped with an acceleration sensor to determine cumulative travel distance and locks the system when the cumulative travel distance reaches a predetermined reference value.

### TECHNICAL FIELD

The present invention relates to a portable information processing apparatus such as a notebook personal computer (hereinafter referred to as a “notebook PC”), system lock program which runs on a portable information processing apparatus such as a notebook PC and locks information processing functions of the portable information processing apparatus, and a system lock program storage medium storing the system lock program.

### BACKGROUND ART

Recently, portable information processing apparatuses including notebook PCs have reached a high level of sophistication and come into wide use, increasing the chances of portable information processing apparatuses being stolen. Although the theft of portable information processing apparatuses themselves presents a problem, the theft of personal information and other secret information stored in the portable information processing apparatuses presents a more serious problem.

Looking at security from that-standpoint, known techniques include, for example, a mechanism for activating a system lock if a device is lifted from a desk and a mechanism for locking the system or erasing data if a rope tied to a device and carrying an electric current is broken as disclosed in Japanese Patent Laid-Open No. 7-248975. These mechanisms are suited to stationary devices, but are not suitable to portable devices which are carried frequently. Also, for example, Japanese Patent Laid-Open No. 2000-165511 proposes a technique for remotely locking a portable telephone by wireless communications. However, this technique requires the user to set the lock intentionally, and is not effective in preventing secret information from being stolen if the user is not aware of the theft. Also, it will be possible to use a system which detects that a person and object are a certain distance away from each other, such as the one described in National Publication of International Patent Application No. 9-500226. In that case, in addition to the object, i.e., a portable information processing apparatus, the person must carry a communications device to conduct communications with the portable information processing apparatus. However, even if the person always carries the communications device, he/she does not always carry around the portable information processing apparatus such as a notebook PC and often uses it on a desk or the like. In that case, the person quits his/her seat frequently, leaving the portable information processing apparatus on the desk or the like. If an ongoing process is interrupted and the system is locked each time, this is very inconvenient.

Also, by advancing the technique for communicating with a portable information processing apparatus, it is conceivable to communicate between a base station and the portable information processing apparatus instead of using a communications device carried by the user and activate the system lock when the portable information processing apparatus is a certain distance away from the base station. In this case, however, since the system lock is activated as the distance from the base station increases, the ability of the portable information processing apparatus to be carried freely is impaired. Thus, this technique is suitable for stationary devices, but not for portable devices.

### DISCLOSURE OF THE INVENTION

In view of the above circumstances, the present invention has an object to provide a portable information processing apparatus which is suitable both for temporary desktop use and for portable use and is configured to reduce the risk of information theft, a system lock program which gives such configuration to the portable information processing apparatus, and a system lock program storage medium storing the system lock program.

To achieve the above object, the present invention provides a portable information processing apparatus which performs information processing, having:

a distance measuring section which determines a cumulative value of travel distance of the portable information processing apparatus; and

a lock control section which activates a lock to disable at least some of information processing functions available on the portable information processing apparatus when the cumulative value of travel distance measured by the distance measuring section reaches a predetermined reference value.

Since the portable information processing apparatus according to the present invention is locked when the cumulative value of the distance traveled by it reaches a predetermined reference value, it is not necessary for the user to carry a communications device or the like aside from the portable information processing apparatus and there is no need for a base station or the like either. If the user specifies a reference value slightly larger than the distance over which the portable information processing apparatus will be carried around, the operability of the portable information processing apparatus will not be impaired when operated on the move and it is highly likely that a lock will be activated before information is stolen in case the portable information processing apparatus is stolen.

In the portable information processing apparatus according to the present invention, preferably the distance measuring section has an acceleration sensor and determines the cumulative value of the travel distance of the portable information processing apparatus based on acceleration obtained by the acceleration sensor.

The type of sensor is not important as long as the portable information processing apparatus according to the present invention measures the cumulative value of its travel distance by itself, but an acceleration sensor can be used typically.

Preferably the portable information processing apparatus according to the present invention has a reference value setting section which sets the reference value variably in response to operator actions.

Also, preferably the portable information processing apparatus has an operator authentication section which authenticates that an operator who operates the portable information processing apparatus is an authorized operator, characterized in that the reference value setting section changes the reference value based on authentication results which indicate that the operator is an authorized operator and on the operator's action of setting the reference value.

The usage of the portable information processing apparatus may vary with the situation: the same user may use the portable information processing apparatus on a desk for some time in one situation and frequently use it on the move under other situations. By providing means of setting the reference value variably in response to operator actions, it is possible to deal with various situations. In this case, security can be stepped up further by authenticating an authorized operator and allowing only the authorized operator to change the reference value.

Furthermore, preferably the portable information processing apparatus according to the present invention has a cumulative value clearing section which clears the cumulative value to its default in response to an operator action. In this case, preferably the portable information processing apparatus has an operator authentication section which authenticates that the operator who operates the portable information processing apparatus is an authorized operator, characterized in that the cumulative value clearing section clears the reference value to its default based on the authentication results which indicate that the operator is an authorized operator and on the operator Is action of clearing the reference value to the default.

By clearing the reference value to the default (typically, the cumulative value of travel distance defaults to zero), it is possible to further adapt the portable information processing apparatus to a new situation. Again, it is preferable to authenticate an authorized operator to prevent unauthorized operation.

The operator authentication section which performs authentication when changing the reference value or clearing it to the default is not limited to those which use a special authentication method. For example, the operator authentication section may have a password input section which accepts input of a password from the operator and judge whether the operator is an authorized operator based on the password entered through the password input section. Alternatively, the operator authentication section may have a fingerprint input section which accepts input of a fingerprint from the operator and judge whether the operator is an authorized operator based on the fingerprint entered through the fingerprint input section. Furthermore, the portable information processing apparatus may have a media access section which accesses a portable storage medium removably mounted on it, characterized in that the operator authentication section judges whether the operator is an authorized operator based on information stored on the portable storage medium mounted on the media access section.

To achieve the above object, the present invention also provides a first system lock program that runs on a portable information processing apparatus which performs information processing, the system lock program giving the portable information processing apparatus a lock function for activating a lock to disable at least some of information processing functions available on the portable information processing apparatus, characterized in that: the portable information processing apparatus is equipped with an acceleration sensor; and

the system lock program has a distance measuring section which determines a cumulative value of travel distance of the portable information processing apparatus based on acceleration obtained by the acceleration sensor, and

a lock control section which activates the lock when the cumulative value of travel distance measured by the distance measuring section reaches a predetermined reference value.

Also, the present invention provides a second system lock program that runs on a portable information processing apparatus which performs information processing, the system lock program giving the portable information processing apparatus a lock function for activating a lock to disable at least some of information processing functions available on the portable information processing apparatus, characterized in that: the portable information processing apparatus is equipped with a distance measuring section which determines a cumulative value of travel distance of the portable information processing apparatus; and

the system lock program has a cumulative value monitor section which monitors the cumulative value of travel distance measured by the distance measuring section, and

a lock control section which activates the lock when the cumulative value of travel distance measured by the distance measuring section reaches a predetermined reference value.

Preferably the system lock program according to the present invention has a reference value setting section which sets the reference value variably. In that case, preferably the system lock program has an operator authentication section which authenticates that an operator who operates the portable information processing apparatus is an authorized operator, and the reference value setting section changes the reference value based on authentication results which indicate that the operator is an authorized operator and on the operator's action of setting the reference value.

Furthermore, preferably the system lock program according to the present invention has a cumulative value clearing section which clears the cumulative value to its default in response to an operator action. In this case, preferably the system lock program has an operator authentication section which authenticates that the operator who operates the portable information processing apparatus is an authorized operator, characterized in that the cumulative value clearing section clears the reference value to its default based on the authentication results which indicate that the operator is an authorized operator and on the operator's action of clearing the reference value to the default.

In the system lock program according to the present invention, the operator authentication section may have a password input section which accepts input of a password from the operator and judge whether the operator is an authorized operator based on the password entered through the password input section. Alternatively, the portable information processing apparatus may have a fingerprint input section which accepts input of a fingerprint from the operator and the operator authentication section may judge whether the operator is an authorized operator based on the fingerprint entered through the fingerprint input section. Furthermore, the portable information processing apparatus may have a media access section which accesses a portable storage medium removably mounted on it, characterized in that the operator authentication section judges whether the operator is an authorized operator based on information stored on the portable storage medium mounted on the media access section.

The present invention also provides a first system lock program storage medium storing a system lock program that runs on a portable information processing apparatus which performs information processing, the system lock program giving the portable information processing apparatus a lock function for activating a lock to disable at least some of information processing functions available on the portable information processing apparatus, characterized in that: the portable information processing apparatus is equipped with an acceleration sensor; and the system lock program has a distance measuring section which determines a cumulative value of travel distance of the portable information processing apparatus based on acceleration obtained by the acceleration sensor, and a lock control section which activates the lock when the cumulative value of travel distance measured by the distance measuring section reaches a predetermined reference value.

The present invention also provides a second system lock program storage medium storing a system lock program that runs on a portable information processing apparatus which performs information processing, the system lock program giving the portable information processing apparatus a lock function for activating a lock to disable at least some of information processing functions available on the portable information processing apparatus, characterized in that: the portable information processing apparatus is equipped with a distance measuring section which determines a cumulative value of travel distance of the portable information processing apparatus; and the system lock program has a cumulative value monitor section which monitors the cumulative value of travel distance measured by the distance measuring section, and a lock control section which activates the lock when the cumulative value of travel distance measured by the distance measuring section reaches a predetermined reference value.

In the system lock program storage medium according to the present invention, preferably the system lock program has a reference value setting section which sets the reference value variably. In that case, preferably the system lock program has an operator authentication section which authenticates that an operator who operates the portable information processing apparatus is an authorized operator, and the reference value setting section changes the reference value based on authentication results which indicate that the operator is an authorized operator and on the operator's action of setting the reference value.

Also, in the system lock program storage medium according to the present invention, preferably the system lock program has a cumulative value clearing section which clears the cumulative value to its default in response to an operator action. In this case, preferably the system lock program has an operator authentication section which authenticates that the operator who operates the portable information processing apparatus is an authorized operator, characterized in that the cumulative value clearing section clears the reference value to its default based on the authentication results which indicate that the operator is an authorized operator and on the operator's action of clearing the reference value to the default.

Also, in the system lock program stored in the system lock program storage medium according to the present invention, the operator authentication section may have a password input section which accepts input of a password from the operator and judge whether the operator is an authorized operator based on the password entered through the password input section. Alternatively, the portable information processing apparatus may have a fingerprint input section which accepts input of a fingerprint from the operator and the operator authentication section may judge whether the operator is an authorized operator based on the fingerprint entered through the fingerprint input section. Furthermore, the portable information processing apparatus may have a media access section which accesses a portable storage medium removably mounted on it, characterized in that the operator authentication section judges whether the operator is an authorized operator based on information stored on the portable storage medium mounted on the media access section.

As described above, the present invention provides a portable information processing apparatus configured to reduce the risk of information theft without the need for a base station or a separate communications device.

### BRIEF DESCRIPTION OF THE DRAWINGS

FIG. 1 is an external perspective view of a notebook PC which operates as an embodiment of a portable information processing apparatus according to the present invention.

FIG. 2 is an internal block diagram of the notebook PC whose outward appearance is shown in FIG. 1.

FIG. 3 is a functional block diagram showing a system lock function of a portable information processing apparatus which is an embodiment of the present invention.

FIG. 4 is a schematic diagram showing an embodiment of a system lock program according to the present invention and system lock program storage medium according to the present invention.

FIG. 5 is a flowchart of a cumulative travel distance monitor program.

FIG. 6 is a flowchart of a system lock setting program.

FIG. 7 is a flowchart of a user authentication program.

FIG. 8 is a diagram showing a user authentication screen.

FIG. 9 is a diagram showing a password input screen.

FIG. 10 is a diagram showing a menu screen.

FIG. 11 is a diagram showing a travel distance input screen for system lock.

FIG. 12 is a diagram showing a distance setting confirmation screen.

FIG. 13 is a diagram showing a message screen which indicates that the cumulative value of travel distance has been cleared to its default value of zero.

FIG. 14 is a diagram showing a message screen which indicates that the system has been locked.

FIG. 15 is a diagram showing a user authentication method setting screen.

FIG. 16 is a diagram showing a user authentication method confirmation screen.

FIG. 17 is an internal block diagram of a notebook PC according to a second embodiment.

FIG. 18 is a schematic diagram showing an embodiment of a system lock program run on the notebook PC whose internal configuration is shown in FIG. 17 and system lock program storage medium storing the system lock program.

FIG. 19 is a flowchart of a cumulative travel distance monitor program.

### BEST MODE FOR CARRYING OUT THE INVENTION

Embodiments of the present invention will be described below. Here, as an example of a portable information processing apparatus according to the present invention, description will be given of a notebook PC.

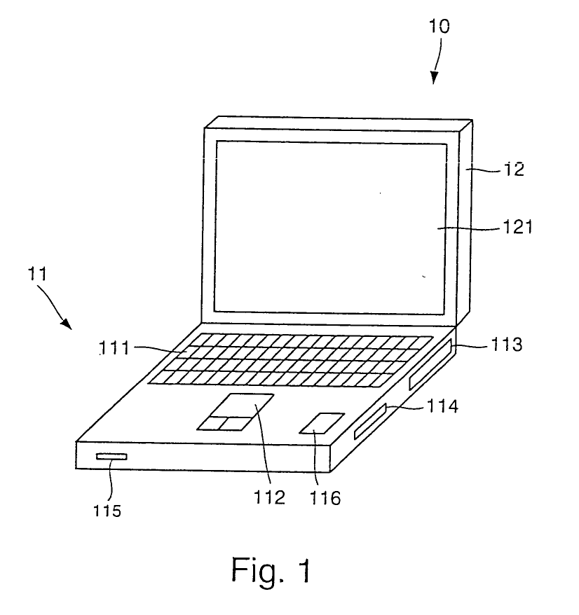

FIG. 1 is an external perspective view of a notebook PC which operates as an embodiment of a portable information processing apparatus according to the present invention.

The notebook PC 10 has a main unit 11 and display panel 12. The display panel 12 is hinged (not shown) to the main unit 11 and can be opened and closed freely.

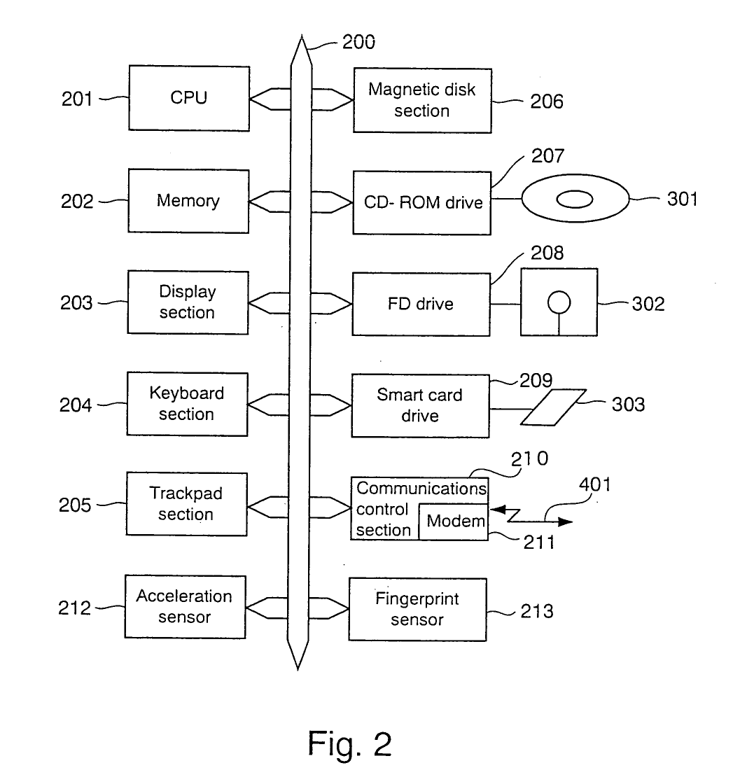

The main unit 11 contains a CPU, magnetic disk, etc., above which a keyboard 111, trackpad 112, etc. are mounted. On a flank, the main unit 11 is equipped with a CD-ROM port 113 in which a CD-ROM is mounted and an FD port 114 in which a flexible disk (FD) is mounted. In the front end, the main unit 11 is equipped with a smart card port 115 in which a smart card is mounted. Furthermore, a fingerprint sensing pad 116 is mounted on the main unit 11. A fingerprint sensor 213 (see FIG. 2) is installed under the fingerprint sensing pad 116. When the tip of a finger is applied to the fingerprint sensing pad 116, the fingerprint on the finger is detected.

The display panel 12 has a liquid-crystal display screen 121 mounted on its front when it is open, as shown in FIG. 1.

FIG. 2 is an internal block diagram of the notebook PC whose outward appearance is shown in FIG. 1.

As shown here, the notebook PC has a CPU 201, a memory 202, a display section 203, a keyboard section 204, a trackpad section 205, a magnetic disk section 206, a CD-ROM drive 207, an FD drive 208, a smart card drive 209, a communications section 210, an acceleration sensor 212, and the fingerprint sensor 213, which are interconnected via a bus 200.

The magnetic disk section 206 is composed of a magnetic disk, magnetic disk drive which drives the magnetic disk, etc. Various programs have been installed on the magnetic disk and the magnetic disk section 206 serves to read these programs as well as to write and store new programs or data on the magnetic disk.

Programs read from the magnetic disk section 206 are loaded into the memory 202 and executed by the CPU 201.

The display section 203 is equipped with the liquid-crystal display screen 121 on the display panel 12 shown in FIG. 1 and serves to display various images on the liquid-crystal display screen 121.

The keyboard section 204 is equipped with the keyboard 111 shown in FIG. 1 and transmits keyboard operations performed by the user of the notebook PC to the CPU 201.

The trackpad section 205 is equipped with the trackpad 112 shown in FIG. 1 and transmits trackpad 112 operations performed by the user to the CPU 201.

The CD-ROM drive 207 accesses a CD-ROM 301 inserted via the CD-ROM port 113 shown in FIG. 1 and uploads programs, data, etc. from the CD-ROM to the notebook PC 10.

The FD drive 208 accesses a flexible disk (FD) 302 inserted in the FD port 114 shown in FIG. 1. It loads data, etc. stored on the FD 302 onto the notebook PC 10 or writes data from the notebook PC into the FD 302. It is possible to upload programs to the notebook PC 10 from the FD 302 rather than from the CD-ROM 301 described above.

Also, the smart card drive 209 accesses a smart card 303 inserted in the smart card port 115 shown in FIG. 1. The smart card 303 contains ID information used to make the notebook PC recognize its owner.

The communications section 210 is equipped with a modem 211. It is connected to the Internet or the like via a communications line 401.

The acceleration sensor 212 detects the acceleration of the notebook PC 10. The notebook PC 10 determines the cumulative value of its travel distance based on the acceleration detected by the acceleration sensor.

As described above, the fingerprint sensor 213 detects the fingerprint on a finger applied to the fingerprint sensing pad 116 shown in FIG. 1.

The programs to which the present invention is applied may be either recorded on a portable recording medium such as the above described CD-ROM or FD and uploaded from it to the notebook PC 10 or recorded in advance on the magnetic disk in the notebook PC 10. Alternatively, the programs to which the present invention is applied may be stored in another device and captured from it via the communications line 401.

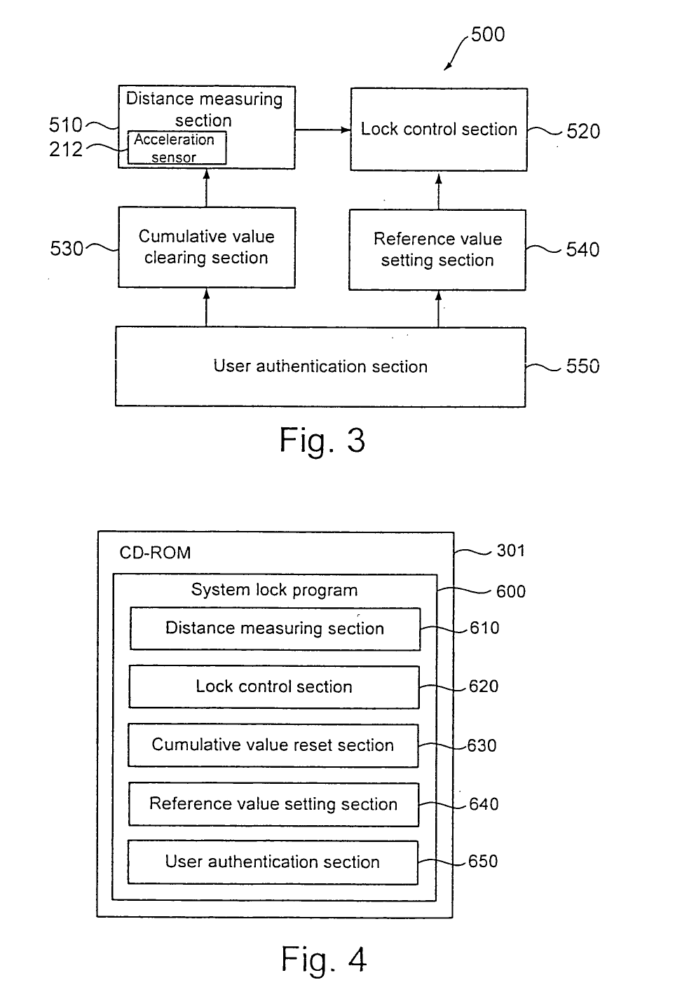

FIG. 3 is a functional block diagram showing a system lock function of a portable information processing apparatus which is an embodiment of the present invention and is composed of the notebook PC 10 shown in FIGS. 1 and 2 and programs running on the notebook PC 10.

The portable information processing apparatus 500 shown in FIG. 3 is composed of a distance measuring section 510 including the acceleration sensor 212 shown also in FIG. 2, lock control section 520, cumulative value clearing section 530, reference value setting section 540, and user authentication section 550.

In the distance measuring section 510, the acceleration sensor 212 detects the acceleration of the notebook PC 10. The detected acceleration is integrated twice, and thereby converted into distance information to determine the cumulative value of the distance traveled by the notebook PC.

According to the present embodiment, the distance measuring section 510 is composed of a combination of the acceleration sensor 212 shown in FIG. 2, a program which determines the cumulative value of the distance traveled by the notebook PC 10 based on the acceleration detected by the acceleration sensor 212, the CPU 201 (see FIG. 2) which executes the program, and so on.

When the cumulative value of the travel distance determined by the distance measuring section 510 reaches a reference value specified in a manner described below, the lock control section 520 in FIG. 3 activates a “lock” to prohibit execution of application programs which can be run on the portable information processing apparatus 500 except an unlock program.

The lock control section 520 is composed of a combination of a program which activates the lock when the cumulative value of the travel distance determined by the distance measuring section 510 exceeds the reference value and hardware such as the CPU 201 (see FIG. 2) which executes the program.

The cumulative value clearing section 530 clears the cumulative value of the travel distance determined by the distance measuring section 510 to the default (zero in this case) in response to a user action. First, user authentication is performed by the user authentication section 550 described later and then the cumulative value is cleared to the default in response to a user action.

The cumulative value clearing section 530 is composed of a combination of the keyboard 111 or trackpad 112 (see FIG. 1) operated by the user, a program which clears the cumulative value to the default in response to a user action, the CPU 201 (see FIG. 2) which executes the program, etc.

The reference value setting section 540 sets, in response to a user action, the reference value to be compared by the lock control section 520 with the cumulative value determined by the distance measuring section 510. As in the case of the cumulative value clearing section 530, user authentication is performed first by the user authentication section 550 and then the reference value setting section 540 sets the reference value by accepting an action from the user authorized by the user authentication section 550.

As in the case of the cumulative value clearing section 530 again, the reference value setting section 540 is composed of a combination of the keyboard 111 or trackpad 112 (see FIG. 1) operated by the user, a program which sets the reference value in response to a user action, the CPU 201 (see FIG. 2) which executes the program, etc.

Furthermore, at the request of the cumulative value clearing section 530 or reference value setting section 540, the user authentication section 550 authenticates the user who is operating the portable information processing apparatus 500 shown in FIG. 3. Then, it reports authentication results to the requesting cumulative value clearing section 530 or reference value setting section 540. According to the present embodiment, the user authentication section 550 also performs authentication before releasing a system lock.

According to the present embodiment, the user authentication section selects any of three user authentication methods: user authentication via an entered password, user authentication by means of a fingerprint, user authentication by means of a smart card 303 (see FIG. 2) inserted in the smart card port 115 (see FIG. 1). The smart card is checked for ID information which indicates that the owner of the smart card is an authorized user.

FIG. 4 is a schematic diagram showing an embodiment of a system lock program according to the present invention and system lock program storage medium according to the present invention.

The system lock program 600 is stored on the CD-ROM 301. The CD-ROM 301 is mounted on the notebook PC 10 through the CD-ROM port 113 (see FIG. 1) and accessed by the CD-ROM drive 207 (see FIG. 2), and thereby the system lock program 600 stored on the CD-ROM 301 is installed on the notebook PC 10. As the installed system lock program 600 is run on the notebook PC, the portable information processing apparatus 500 shown in FIG. 3 is implemented.

The system lock program 600 is composed of program components: a distance measuring section 610, lock control section 620, cumulative value clearing section 630, reference value setting section 640, and user authentication section 650.

The program components 610 to 650 composing the system lock program 600 and carrying the same name as the components 510 to 550 of the portable information processing apparatus 500 shown in FIG. 3 correspond to the respective components 510 to 550. However, whereas the components 510 to 550 composing the portable information processing apparatus 500 shown in FIG. 3 are constituted of combinations of hardware and software, the program components 610 to 650 composing the system lock program 600 in FIG. 4 are constituted only of application programs. The program components 610 to 650 operate in the same manner as the corresponding components 510 to 550 of the portable information processing apparatus 500 shown in FIG. 3, and thus, redundant description will be omitted.

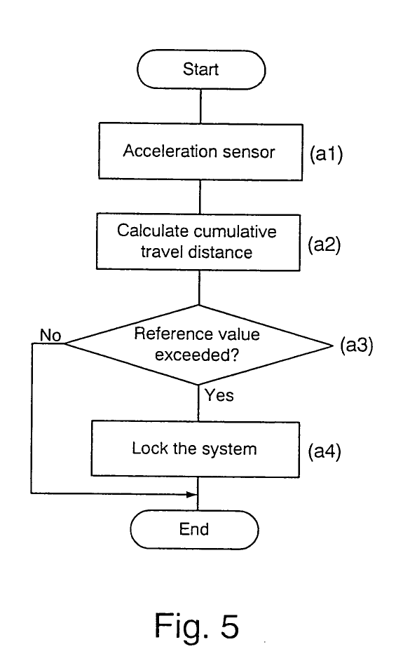

FIG. 5 is a flowchart of a cumulative travel distance monitor program.

Steps a1 to a2 of the cumulative travel distance monitor program correspond to the distance measuring section 610 in FIG. 4 and steps a3 to a4 correspond to the lock control section 620 in FIG. 4.

The cumulative travel distance monitor program shown in FIG. 5 repeats its operation periodically when the notebook PC in FIGS. 1 and 2 is powered on and the system is not locked.

When the cumulative travel distance monitor program begins execution, first it monitors the acceleration obtained by the acceleration sensor 212 shown in FIG. 2 (step a1), determines the distance traveled by the notebook PC 10 this time, based on the acceleration, and adds this distance to the cumulative travel distance so far to calculate new cumulative travel distance (cumulative value of travel distance).

Next, the cumulative travel distance monitor program judges whether the calculated cumulative travel distance exceeds the reference value (step a3). If the reference value has not been exceeded yet, the cumulative travel distance monitor program just finishes processing this time. On the other hand, if the reference value has been exceeded, the system is locked in step a4.

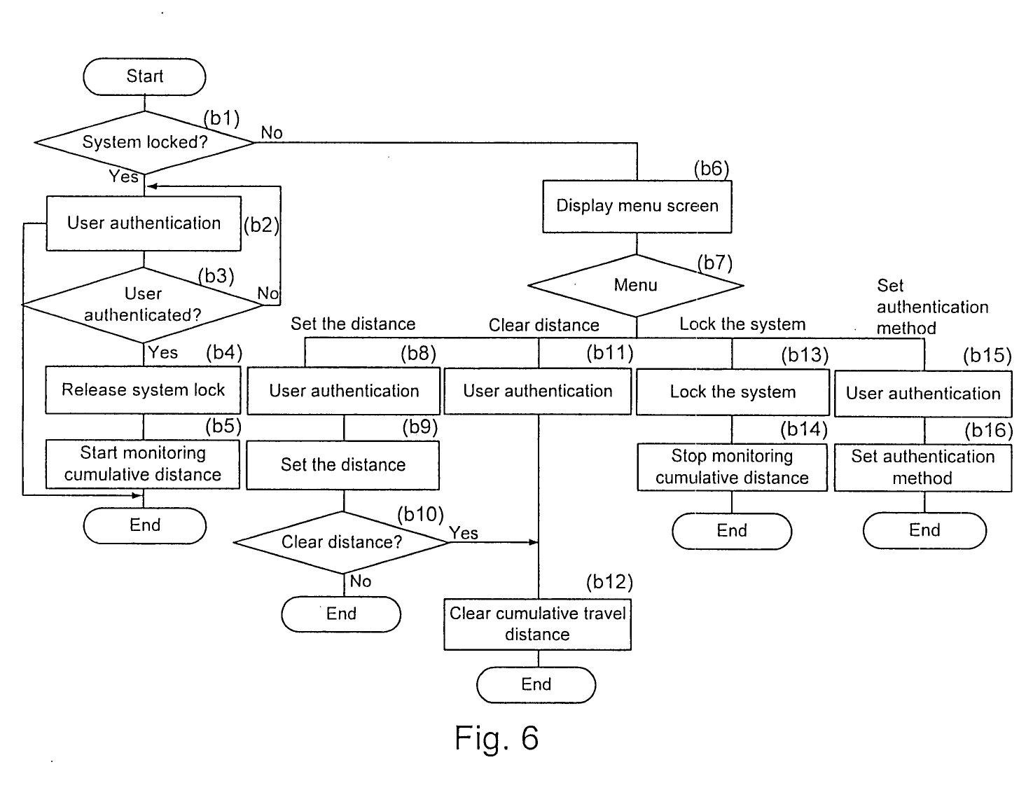

FIG. 6 is a flowchart of a system lock setting program.

First, the system lock setting program judges whether the system is locked (step b1). If the system is locked, user authentication is performed (step b2).

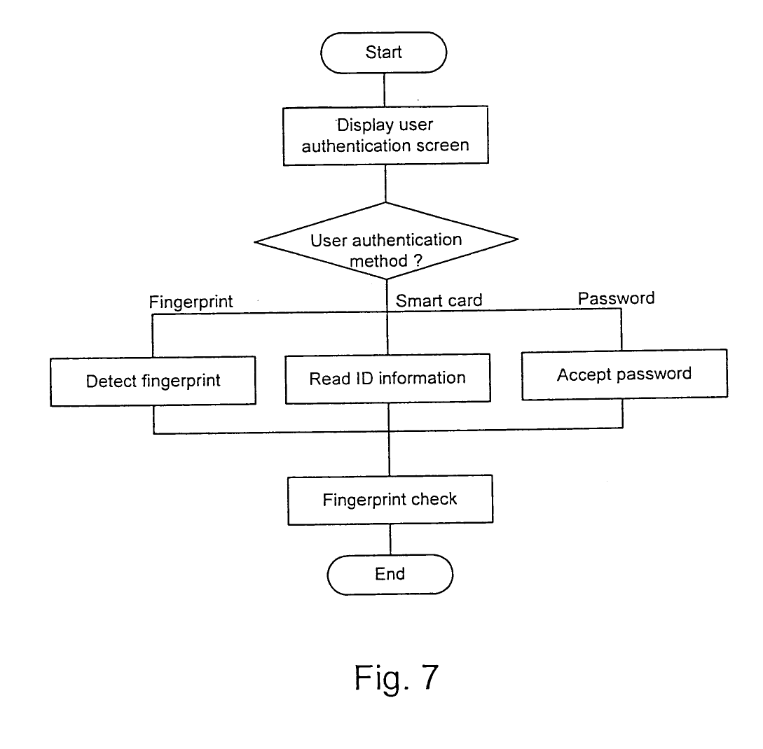

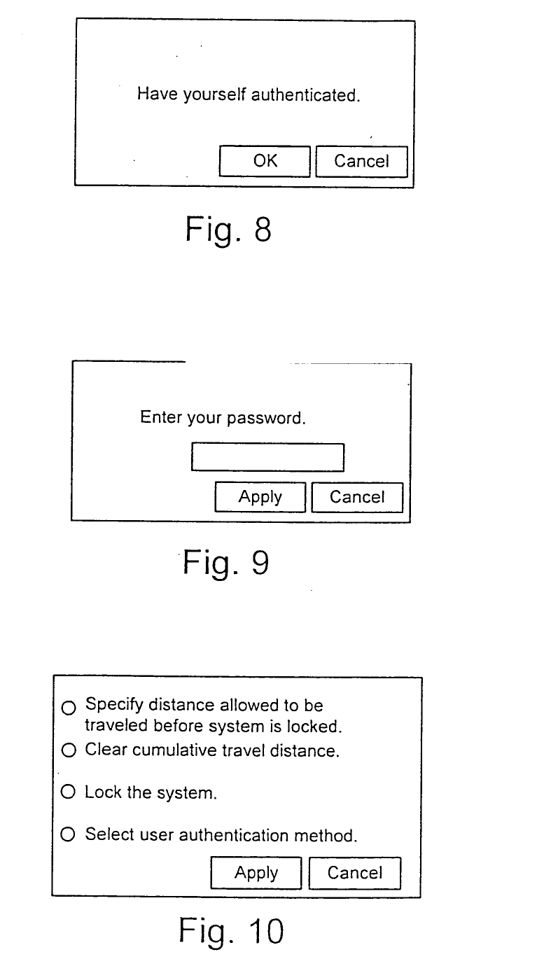

FIG. 7 is a flowchart of a user authentication program and FIG. 8 is a diagram showing a user authentication screen.

When any of the keys on the keyboard 111 of the notebook PC 10 is pressed while the system is being locked, a user authentication screen such as the one shown in FIG. 8 appears on the liquid-crystal display screen 121 of the notebook PC 10 shown in FIG. 1 (step c1).

In this example, one of the user authentication methods—the password-based method, fingerprint-based method, and method based on ID information in a smart card—has been selected in advance (see also step b16 in FIG. 6 described later) and the user authentication program judges which user authentication method has been selected (step c2).

If the fingerprint-based user authentication method has been specified, when an “OK” button on the user authentication screen in FIG. 8 is pressed, the user authentication program goes to step c3, where the fingerprint sensor 213 detects the fingerprint on a finger applied to the fingerprint sensing pad shown in FIG. 1 and the program captures the detected fingerprint.

In step c6, the captured fingerprint is checked against fingerprints of preregistered users. Then, in step b3 in FIG. 6, it is judged whether the captured fingerprint is a fingerprint of a legitimate user, based on the results of the fingerprint check in step c6. If it is a fingerprint of a legitimate user, the system lock is released in step b4 and the cumulative travel distance monitor program shown in FIG. 5 is enabled in step b5. After being enabled in step 5, the cumulative travel distance monitor program in FIG. 5 repeats its operation periodically until it is disabled in step b14 described later. If the user authentication (step b2) fails and the user is not confirmed to be legitimate (step b3), the user authentication screen in FIG. 8 is brought up again. A “Cancel” button in FIG. 8 is used to cancel user authentication procedures.

If the user authentication method based on ID information in a smart card has been selected, when the user inserts a smart card 303 (see FIG. 2) in the smart card port 115 in FIG. 1 after the screen in FIG. 7 is displayed and presses the “OK” button in FIG. 7, ID information is read from the smart card 303 (step c4 in FIG. 7) and checked against preregistered ID information (step c6). If the read ID information belongs to a legitimate user (step b3), the system is unlocked (step b4).

FIG. 9 is a diagram showing a password input screen.

If the password-based user authentication method has been selected, when the user presses the “OK” button on the user authentication screen in FIG. 8, the password input screen shown in FIG. 9 appears, allowing the user to enter a password (step c5).

When the user enters a password in the password input screen in FIG. 9 and clicks an “Apply” button, the entered password is checked against preregistered passwords (step c6) and if the entered password belongs to a legitimate user (step b3), the system is unlocked (step b4).

If the system is not locked, i.e., if the system lock is off, the system lock setting program in FIG. 6 is executed when a particular function key on the keyboard 111 (see FIG. 1) is pressed or a particular icon displayed on the liquid-crystal display screen is clicked.

If it is judged in step b1 in FIG. 6 that the system is not locked, the processing goes to step c6, where a menu screen is displayed.

FIG. 10 is a diagram showing a menu screen.

Four items are shown here: “Specify distance allowed to be traveled before system is locked,” “Clear cumulative travel distance,” “Lock the system,” and “Select user authentication method.” When one of the radio buttons is checked and the “Apply” button is clicked, a process which corresponds to the item selected by checking the radio button is started (step b7).

If “Specify distance allowed to be traveled before system is locked” is selected, the processing goes to step b8, where user authentication is performed. Since user authentication methods have already been described with reference to FIG. 7, redundant description thereof will be omitted here. If user authentication in step b8 is successful, the processing goes to step b9, where the distance allowed to be traveled before the system is locked is set.

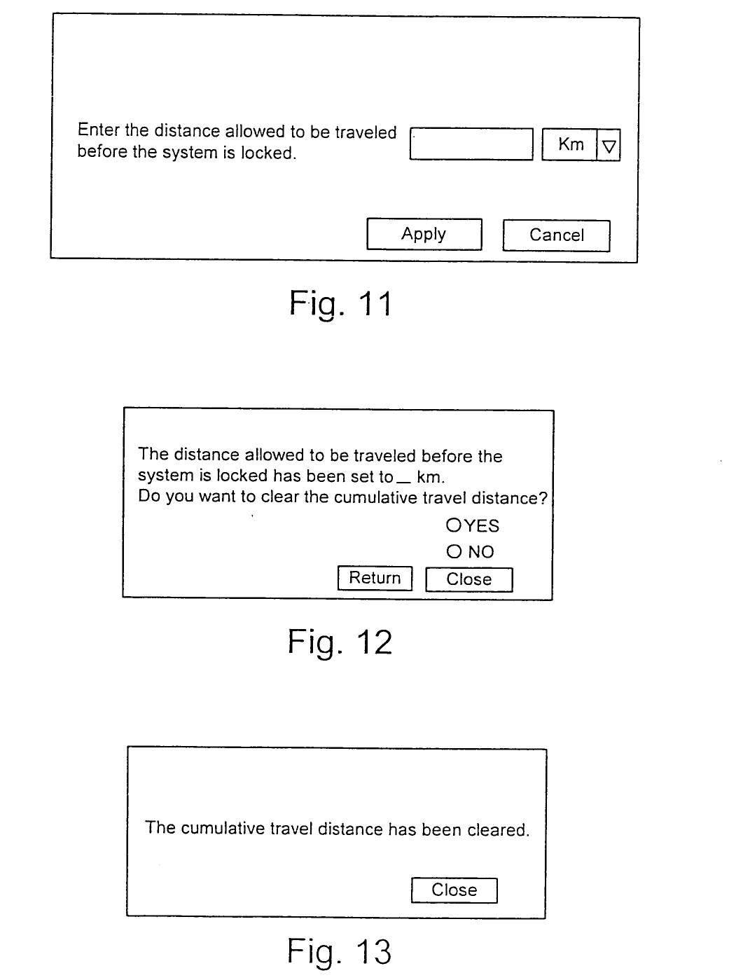

FIG. 11 is a diagram showing a travel distance input screen for system lock and FIG. 12 is a diagram showing a distance setting confirmation screen.

On the screen in FIG. 11, the numeric value of the travel distance is entered and the unit of distance is selected from among “m” and “km.” For mostly desktop use, the use of the unit “m” is convenient. For frequent use on the move, the use of the unit “km” is convenient. When the user makes distance settings and clicks the “Apply” button, the distance setting confirmation screen shown in FIG. 12 appears.

The screen shown in FIG. 12 displays the distance just entered, allowing the user to confirm the distance setting. By clicking a “Return” button, the user can return to the screen in FIG. 11 and specify the travel distance anew.

The screen in FIG. 12 also displays a question “Do you want to clear the cumulative travel distance?” prompting the user to give a “YES” or “NO” answer. When the user checks the “YES” or “NO” radio button and clicks a “Close” button, the screen in FIG. 12 closes.

In step b10 in FIG. 6, it is judged which was selected on the screen in FIG. 12 from among “YES” and “NO.” If “NO” was selected, the processing is just finished. That is, regarding the distance allowed to be traveled before the system is locked, the setting made this time comes into effect, but the cumulative value of travel distance calculated so far is not cleared, the current value is retained, and the distance traveled from now on will be added to it.

If “YES” was selected on the screen in FIG. 12, the processing goes to step b12, the cumulative value of travel distance calculated so far is cleared to the default value of zero. That is, regarding the distance allowed to be traveled before the system is locked, the setting made this time comes into effect, and the cumulative value of travel distance calculated so far is cleared to the default value of zero.

FIG. 13 is a diagram showing a message screen which indicates that the cumulative value of travel distance has been cleared to its default value of zero.

When the cumulative value of travel distance is cleared to its default value of zero, the screen shown in FIG. 13 appears, notifying the user that the cumulative travel distance has been cleared successfully. When the user clicks the “Close” button on the screen in FIG. 13, the screen in FIG. 13 disappears.

If “Clear cumulative travel distance” is selected on the menu screen in FIG. 10, user authentication is performed in step b11 in FIG. 6. If the user authentication is successful, the cumulative value of travel distance is cleared to its default value of zero in step b12. As with the above case, the screen in FIG. 13 appears, notifying the user that the cumulative travel distance has been cleared successfully.

If “Lock the system” is selected on the menu screen in FIG. 10, the system is locked in step b13 in FIG. 6 and the cumulative travel distance is stopped to be monitored in step b14. Subsequently, the cumulative travel distance monitor program shown in FIG. 5 is disabled.

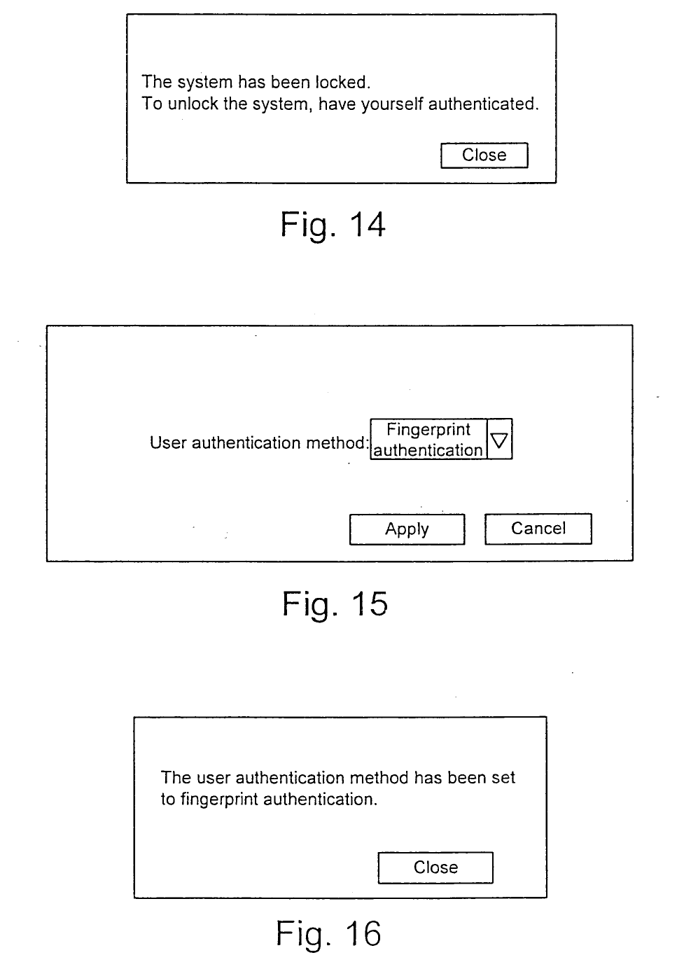

FIG. 14 is a diagram showing a message screen which indicates that the system has been locked.

The screen in FIG. 14 notifies the user that the system has been locked successfully. When the user clicks a “Close” button on the screen in FIG. 14, the screen in FIG. 14 disappears.

If “Select user authentication method” is selected on the menu screen in FIG. 10, user authentication is performed using the method so far in step b15 in FIG. 6 and if the user authentication is successful, the authentication method is changed (a new authentication method is selected) in step b16.

FIG. 15 is a diagram showing a user authentication method setting screen.

One of three methods is allowed to be selected here: “Password authentication,” “Fingerprint authentication,” and “ID authentication.” When the user selects one of them and clicks the “Apply” button, the authentication method selected this time comes into effect subsequently.

If the user clicks the “Cancel” button on the screen in FIG. 15, the screen in FIG. 15 disappears and the previous user authentication method remains in effect.

FIG. 16 is a diagram showing a user authentication method confirmation screen.

When the user selects an authentication method and clicks the “Apply” button on the screen in FIG. 15, a user authentication method confirmation screen such as the one shown in FIG. 16 appears. The screen shown in FIG. 16 allows the user to confirm the new user authentication method. When the user clicks the “Close” button on the screen in FIG. 16, the screen in FIG. 16 disappears.

In the above embodiment, the hardware of the notebook PC is equipped with the acceleration sensor 212 as shown in FIG. 2, cumulative travel distance is calculated by an application program shown in FIG. 5 based on the acceleration detected by the acceleration sensor 212, but alternatively the notebook PC may contain a module which calculates the cumulative travel distance and application programs may take charge of processes beginning with the process of monitoring the cumulative travel distance calculated by the module.

Differences of an embodiment (second embodiment) thus configured from the above described embodiment will be described below.

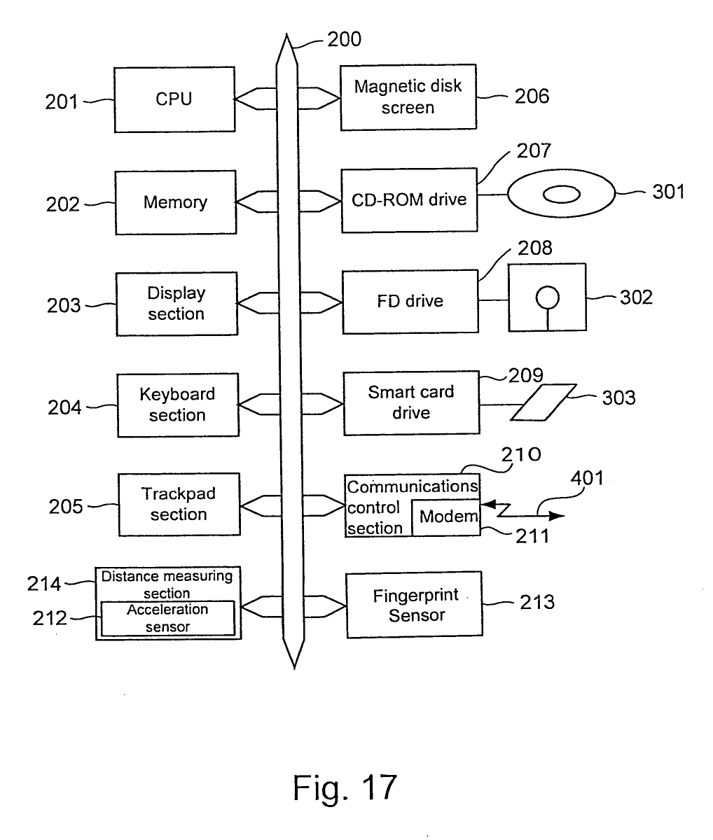

FIG. 17 is an internal block diagram of a notebook PC according to the second embodiment.

Instead of the acceleration sensor 212 (see FIG. 2) of the above embodiment, the second embodiment is equipped with a modularized distance measuring section 213 which includes the acceleration sensor 212. The distance measuring section 213 determines the cumulative travel distance based on the acceleration detected by the acceleration sensor 212. The other components shown in the internal block diagram in FIG. 17 are the same as the corresponding components shown in the internal block diagram in FIG. 2, and thus redundant description thereof will be omitted.

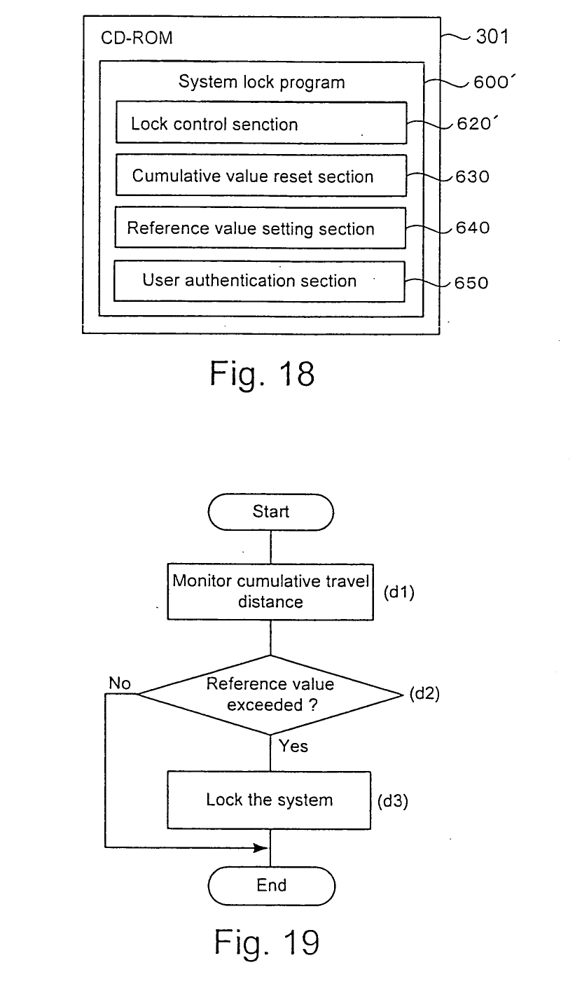

FIG. 18 is a schematic diagram showing an embodiment of a system lock program run on the notebook PC whose internal configuration is shown in FIG. 17 and system lock program storage medium storing the system lock program.

As in the case of FIG. 4, the system lock program 6001 is stored on the CD-ROM 301. The system lock program 600′ stored on the CD-ROM 301 is installed and run on the notebook PC whose internal configuration is shown in FIG. 17.

When the system lock program 600′ shown in FIG. 18 is compared with the system lock program 600 shown in FIG. 4, the system lock program 600′ in FIG. 18 does not have a software component which corresponds to the distance measuring section 610 of the system lock program 600 in FIG. 4. This is because the notebook PC itself is equipped with a hardware module, the distance measuring section 213 (FIG. 17), and consequently there is no need to determine cumulative travel distance using application software. Also, the lock control section 620′ of the system lock program 600′ shown in FIG. 18 is slightly different from the lock control section 620 of the system lock program 600 shown in FIG. 4. The cumulative value clearing section 630, reference value setting section 640, and user authentication section 650 are identical to the corresponding program components of the system lock program 600 shown in FIG. 4.

FIG. 19 is a flowchart of a cumulative travel distance monitor program. The cumulative travel distance monitor program corresponds to the lock control section 620′ in FIG. 18.

The cumulative travel distance monitor program is executed repeatedly on a periodic basis from the time it is enabled in step b5 of the system lock setting program shown in FIG. 6 until the time it is stopped in step 14, as is the case with the cumulative travel distance monitor program according to the above embodiment shown in FIG. 5.

In step d1 in FIG. 19, the cumulative travel distance of the notebook PC determined by the distance measuring section 213 shown in FIG. 17 is monitored. In step d2, it is judged whether the monitored travel distance has exceeded a reference value. If the cumulative travel distance has not exceeded the reference value, the processing is finished, but if the reference value has been exceeded, the system is locked (step d3).

The second embodiment described here is the same as the embodiment described earlier except for what has been described with reference to FIGS. 17 to 19, and thus redundant description thereof will be omitted.

Next, another embodiment will be described.

Although the embodiments described so far use a system lock program to lock information processing functions, the portable information processing apparatus according to the present invention is not limited to the use of a system lock program described above. For example, a firmware-level system lock program stored on a flash ROM may be used to lock information processing functions. This can provide higher security than the use of a system lock program described above.

A case in which information processing functions are locked by such a firmware-level system lock program will be described with reference to FIG. 17.

Even if the notebook PC is powered off, the distance measuring section 213 continues to draw power. The distance measuring section 213 includes not only a function to determine cumulative travel distance of the notebook PC, but also a function to compare the determined cumulative travel distance with a reference value. When the cumulative travel distance determined by the distance measuring section 213 exceeds the reference value, power is supplied to the relevant part of the notebook PC to lock the system. This configuration allows the system lock program to lock the system in a manner transparent to the user.

Incidentally, although all the embodiments described above relate to a notebook PC, the present invention can also be applied to other portable information processing apparatuses such as portable telephones and various multifunction devices.

What is claimed is:

1. A portable information processing apparatus which performs information processing, comprising:
a distance measuring section which determines a cumulative value of travel distance of the portable information processing apparatus; and
a lock control section which activates a lock to disable at least some of information processing functions available on the portable information processing apparatus when the cumulative value of travel distance measured by the distance measuring section reaches a predetermined reference value.

2. The portable information processing apparatus according to claim 1, wherein the distance measuring section has an acceleration sensor and determines the cumulative value of the travel distance of the portable information processing apparatus based on acceleration obtained by the acceleration sensor.

3. The portable information processing apparatus according to claim 1, comprising a reference value setting section which sets the reference value variably in response to operator actions.

4. The portable information processing apparatus according to claim 3, comprising an operator authentication section which authenticates that an operator who operates the portable information processing apparatus is an authorized operator,
wherein the reference value setting section changes the reference value based on authentication results which indicate that the operator is an authorized operator and on the operator's action of setting the reference value.

5. The portable information processing apparatus according to claim 1, comprising a cumulative value clearing section which clears the reference value to a default value in response to an operator action.

6. The portable information processing apparatus according to claim 5, comprising an operator authentication section which authenticates that the operator who operates the portable information processing apparatus is an authorized operator,
wherein the cumulative value clearing section clears the reference value to a default value based on the authentication results which indicate that the operator is an authorized operator and on the operator's action of clearing the reference value to the default value.

7. The portable information processing apparatus according to claim 1, wherein the operator authentication section comprises a password input section which accepts input of a password from the operator and the operator authentication section judges whether the operator is an authorized operator based on the password entered through the password input section.

8. The portable information processing apparatus according to claim 1, wherein the operator authentication section comprises a fingerprint input section which accepts input of a fingerprint from the operator and the operator authentication section judges whether the operator is an authorized operator based on the fingerprint entered through the fingerprint input section.

9. The portable information processing apparatus according to claim 1, comprising a media access section which accesses a portable storage medium removably mounted on thereon, wherein the operator authentication section judges whether the operator is an authorized operator based on information stored on the portable storage medium mounted on the media access section.

10. A system lock program that runs on a portable information processing apparatus which performs information processing, the system lock program giving the portable information processing apparatus a lock function for activating a lock to disable at least some of information processing functions available on the portable information processing apparatus, wherein:
the portable information processing apparatus is equipped with an acceleration sensor; and
the system lock program comprises a distance measuring section which determines a cumulative value of travel distance of the portable information processing apparatus based on acceleration obtained by the acceleration sensor, and
a lock control section which activates the lock when the cumulative value of travel distance measured by the distance measuring section reaches a predetermined reference value.

11. A system lock program that runs on a portable information processing apparatus which performs information processing, the system lock program giving the portable information processing apparatus a lock function for activating a lock to disable at least some of information processing functions available on the portable information processing apparatus, wherein:
the portable information processing apparatus is equipped with a distance measuring section which determines a cumulative value of travel distance of the portable information processing apparatus; and
the system lock program comprises a cumulative value monitor section which monitors the cumulative value of travel distance measured by the distance measuring section, and `
a lock control section which activates the lock when the cumulative value of travel distance measured by the distance measuring section reaches a predetermined reference value.

12. A system lock program storage medium storing a system lock program that runs on a portable information processing apparatus which performs information processing, the system lock program giving the portable information processing apparatus a lock function for activating a lock to disable at least some of information processing functions available on the portable information processing apparatus, wherein:
the portable information processing apparatus is equipped with an acceleration sensor; and
the system lock program comprises a distance measuring section which determines a cumulative value of travel distance of the portable information processing apparatus based on acceleration obtained by the acceleration sensor, and
a lock control section which activates the lock when the cumulative value of travel distance measured by the distance measuring section reaches a predetermined reference value.

13. A system lock program storage medium storing a system lock program that runs on a portable information processing apparatus which performs information processing, the system lock program giving the portable information processing apparatus a lock function for activating a lock to disable at least some of information processing functions available on the portable information processing apparatus, wherein:
the portable information processing apparatus is equipped with a distance measuring section which determines a cumulative value of travel distance of the portable information processing apparatus; and
the system lock program comprises a cumulative value monitor section which monitors the cumulative value of travel distance measured by the distance measuring section, and
a lock control section which activates the lock when the cumulative value of travel distance measured by the distance measuring section reaches a predetermined reference value.
